(19) United States
(12) Patent Application Publication
(10) Pub. No.: US 2005/0089381 A1
(43) Pub. Date: Apr. 28, 2005

(54) Wood-drilling apparatus

(76) Inventors: Hsu Hsiu-Kwei Liu, Feng Yuan City (TW); Ming-Hsiang Chiu, Chia Yi City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/694,095

(22) Filed: Oct. 27, 2003

(51) Int. Cl. B23B 49/02

(52) U.S. Cl. 408/115 R

(57) ABSTRACT

A wood-drilling apparatus includes a table, a wall, at least one cylinder, a jig and at least one drill. The wall is installed on the table. The cylinder is vertically movably mounted on the wall. The cylinder defines an inclined passageway. The jig is installed on the table for pushing a workpiece against the cylinder. The drill is movably inserted in the inclined passageway for drilling the workpiece.

### FIELD OF INVENTION

The present invention relates to a wood-drilling apparatus.

### BACKGROUND OF INVENTION

FIG. 11 shows a first conventional wood-drilling apparatus including a table 1, a wall 6 extending from the table 1, a jig 2 attached to the table 1 and two cylinders 3 put movably on the wall 6. Each of the cylinders 3 is retained in position relative to the wall 6 by means of a screw 4. Each of the cylinders 3 includes an inclined passageway 5 defined therein for receiving a drill. A wooden workpiece includes a front face, a rear face, a bottom and a top. The distance measured from the front face to the rear face will be referred to as “thickness” hereinafter. The wooden workpiece is put between the jig 2 and the cylinders 3. The front face is put against the cylinders 3, and the bottom the table 1. The drills are driven into the wooden workpiece, from the front face to the bottom. Thus, two holes are drilled in the wooden workpiece. Each hole includes a first open end in the front face and a second open end in the bottom. It is desired that the center of the second open end is located at the center of the thickness. However, this requires different pairs of cylinders for wooden workpieces of different thickness since the cylinders 3 cannot be moved vertically.

FIGS. 12 and 13 show a second conventional wood-drilling apparatus that is identical to the first conventional wood-drilling apparatus except for using a holding device instead of the screws 4. The holding device includes a screw 9 extending through the wall 6, a sleeve 8 for receiving the screw 9 and a rod 7 extending through the sleeve 8 into each of the cylinders 3. A thread is formed on the screw 9. On an internal side of the sleeve 8 is formed a thread engaged with the thread of the screw 9. The cylinders 3 can be moved horizontally along the rod 7, and can be retained in position via engaging the screw 9 with the sleeve 8. Like the cylinders 3 in the first conventional wood-drilling apparatus, the cylinders 3 in the second conventional wood-drilling apparatus cannot be moved vertically.

The present invention is therefore intended to obviate or at least alleviate the problems encountered in prior art.

### SUMMARY OF INVENTION

The primary objective of this invention is to provide a wood-drilling apparatus for boring a wooden workpiece with holes in various positions.

A wood-drilling apparatus includes a table, a wall, at least one cylinder, a jig and at least one drill. The wall is installed on the table. The cylinder is vertically movably mounted on the wall. The cylinder defines an inclined passageway. The jig is installed on the table for pushing a workpiece against the cylinder. The drill is movably inserted in the inclined passageway for drilling the workpiece.

Other objects, advantages and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a wood-drilling apparatus according to a first embodiment of the present invention.

FIG. 2 is an exploded view of the wood-drilling apparatus of FIG. 1.

FIG. 3 is a partial cross-sectional view of the wood-drilling apparatus with a drill.

FIG. 4 is similar to FIG. 3 but shows a cylinder and a screw of the wood-drilling apparatus in another position.

FIG. 5 is similar to FIG. 4 but shows the cylinder and the screw in another position.

FIG. 6 is a top view of the wood-drilling apparatus.

FIG. 7 is a partial cross-sectional view of the wood-drilling apparatus of FIG. 6.

FIG. 8 is a partially cross-sectional view of a wood-drilling apparatus according to a second embodiment of the present invention.

FIG. 9 is a front perspective view of a wall and two cylinders of the wood-drilling apparatus of FIG. 8.

FIG. 10 is a rear perspective view of the wall and the cylinders of FIG. 9.

FIG. 11 is a conventional wood-drilling apparatus.

FIG. 12 is a conventional wood-drilling apparatus.

FIG. 13 is a conventional wood-drilling apparatus.

### DETAILED DESCRIPTION OF EMBODIMENTS

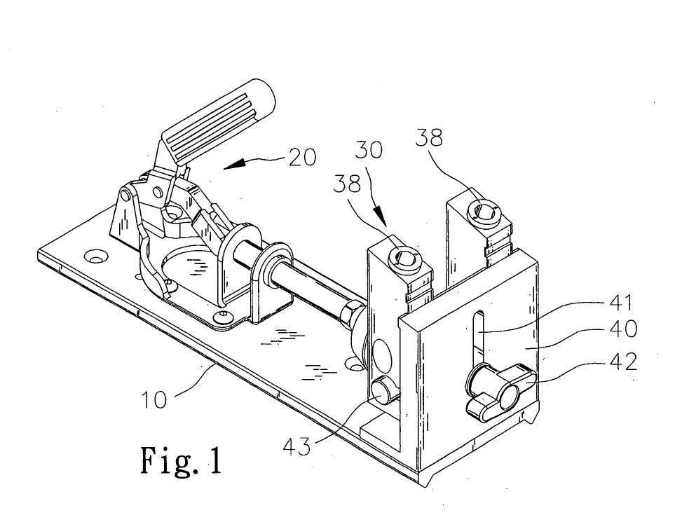

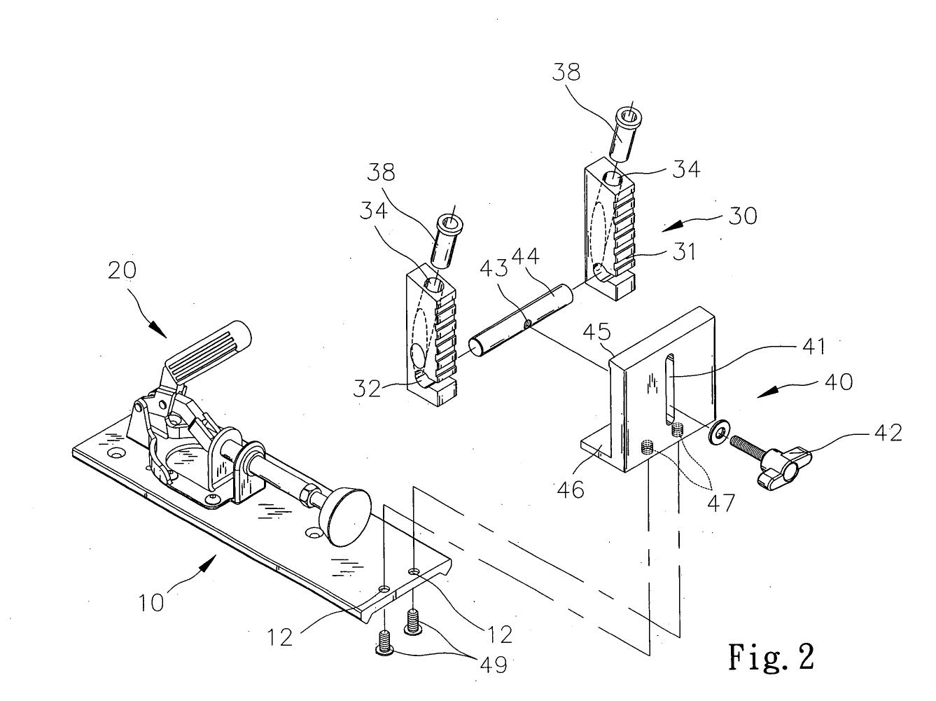

Referring to FIGS. 1 to 7, according to a first embodiment of the present invention, a wood-drilling apparatus includes a table 10, a jig 20 attached to the table 10, a wall 40 attached to the table 10 and two cylinders 30 mounted on the wall 40.

The base 10 defines two apertures 12. The table 10 and the jib 20 will not be described in detail for being conventional. However, the wall 40 and the cylinders 30 will be described in detail.

Each of the cylinders 30 includes several ribs 31 formed thereon. Each of the cylinders 30 defines a hole 32 and an inclined passageway 34 for receiving a drill 36.

A rod 43 defines a screw hole 44. The rod 43 is inserted in the holes 32.

Thus, the cylinders 30 are smoothly movable along the rod 43.

The wall 40 includes a vertical slot 41 defined therein, a rib 45 formed thereon, a base 46 extending from a lower portion thereof and two screw holes 47 defined in the base 46.

Two screws 49 are driven into the screw holes 47 through the apertures 12, thus securing the wall 40 to the table 10.

A screw 42 is driven through the vertical slot 41 into the screw hole 44. The cylinders 30 are movable vertically on the wall 40 as the screw 42 is movable in the vertical slot 41. The cylinders 30 can be forced against the wall 40 via engaging the screw 42 with the rod 43. The ribs 31 can be engaged with the rib 45 so as to retain the cylinders 30 in a desired vertical position on the wall 40.

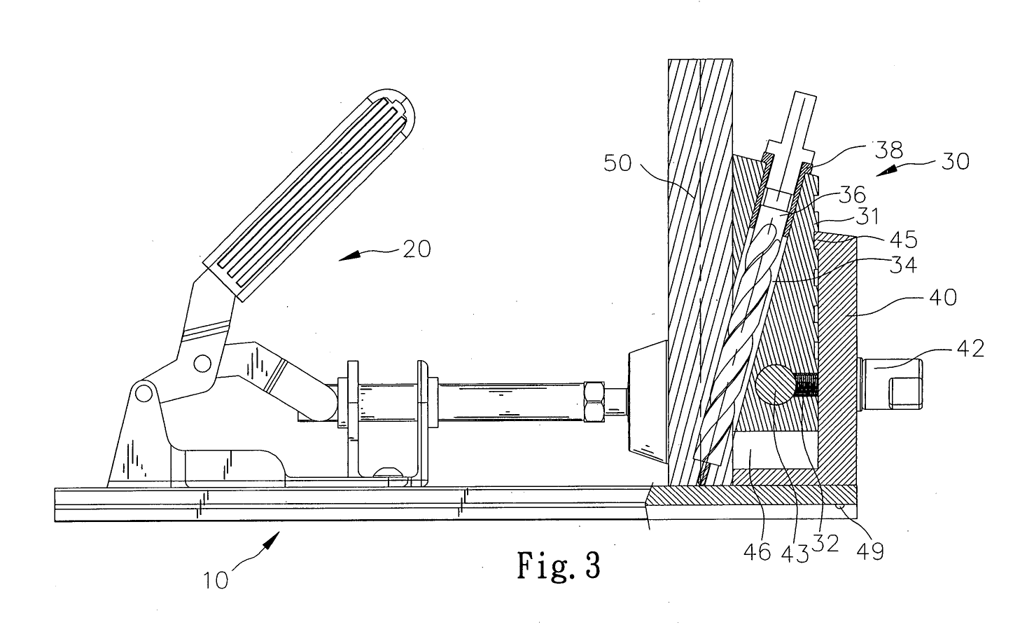

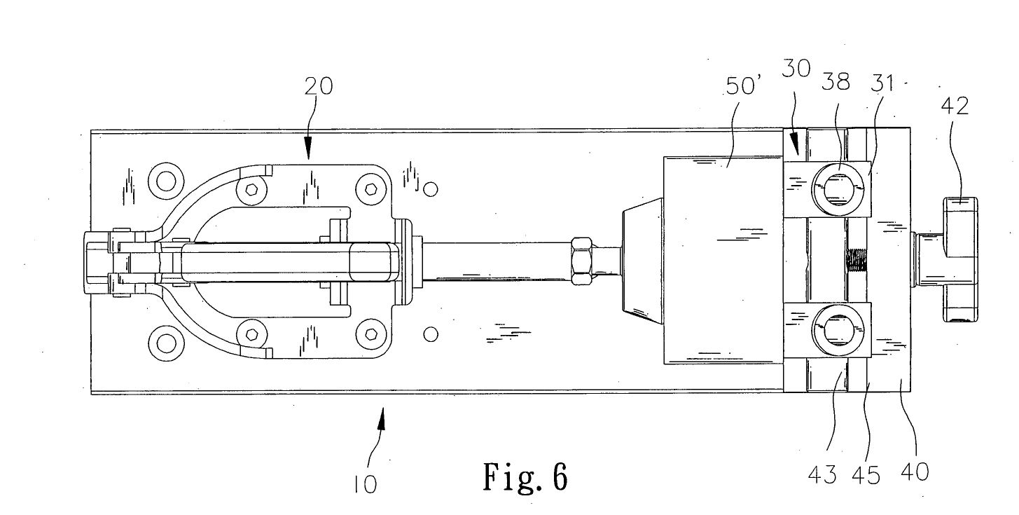

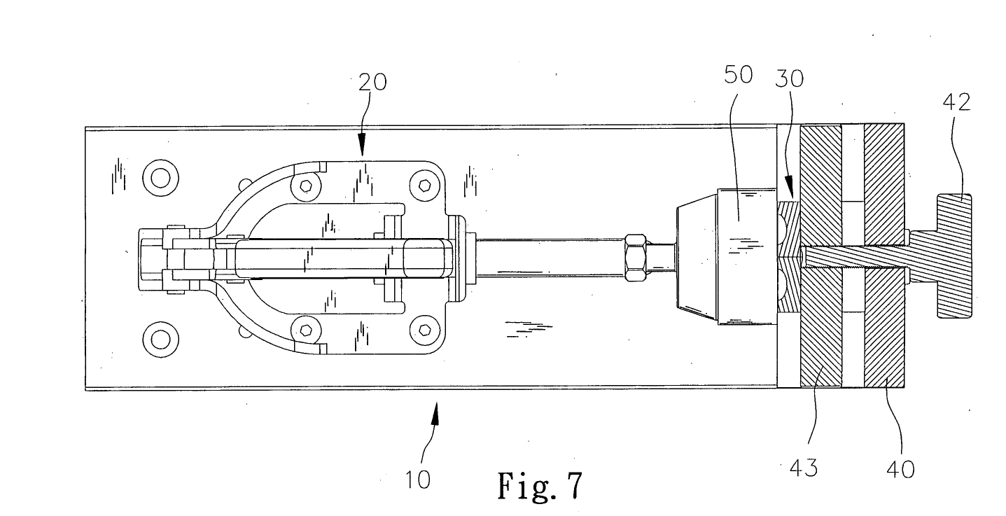

Referring to FIG. 3, one of the ribs 31 of the cylinders 30 is supported on the rib 45 of the wall 40. The screw 42 is securely engaged with the screw hole 44 as best shown in FIGS. 6 and 7. Thus, the cylinders 30 are retained in position on the wall 40.

A wooden workpiece 50 includes a front face, a rear face, a bottom and a top. The distance measured from the front face to the rear face will be referred to as “thickness” hereinafter. The wooden workpiece 50 is put on the table 10 and between the jig 20 and the cylinders 30. The front face is put against the cylinders 30, and the bottom the table 10. The drills 36 are driven into the wooden workpiece 50, from the front face to the bottom.

Thus, two holes are drilled in the wooden workpiece. Each hole includes a first open end in the front face and a second open end in the bottom. Since the cylinders 30 are vertically movable on the wall 40, it is ensured that the center of the second open end be located at the center of the thickness whatever the thickness may be.

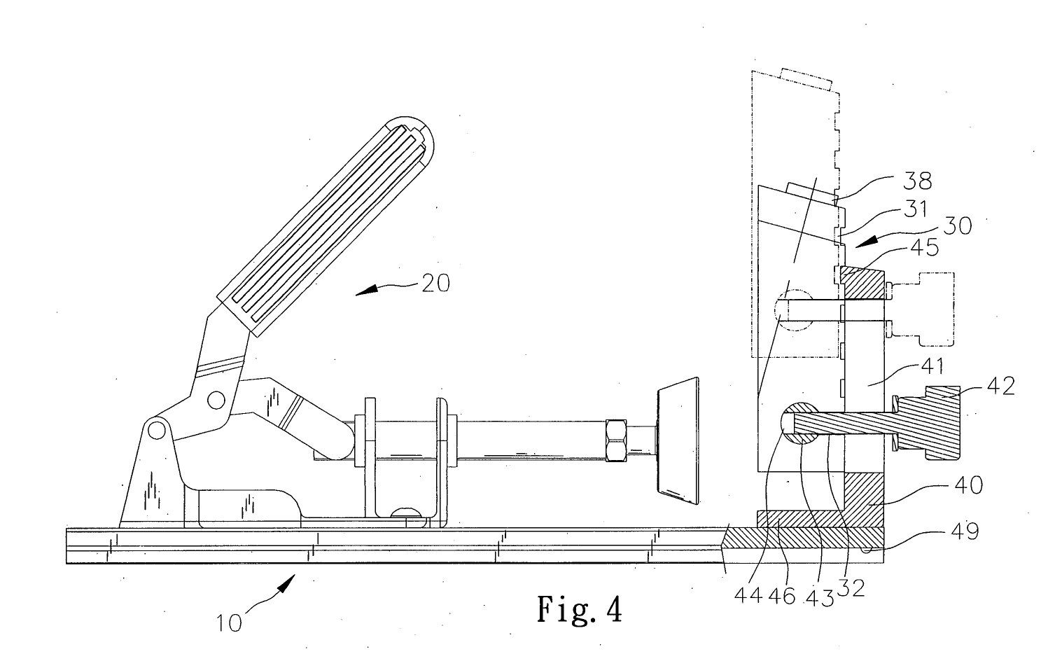

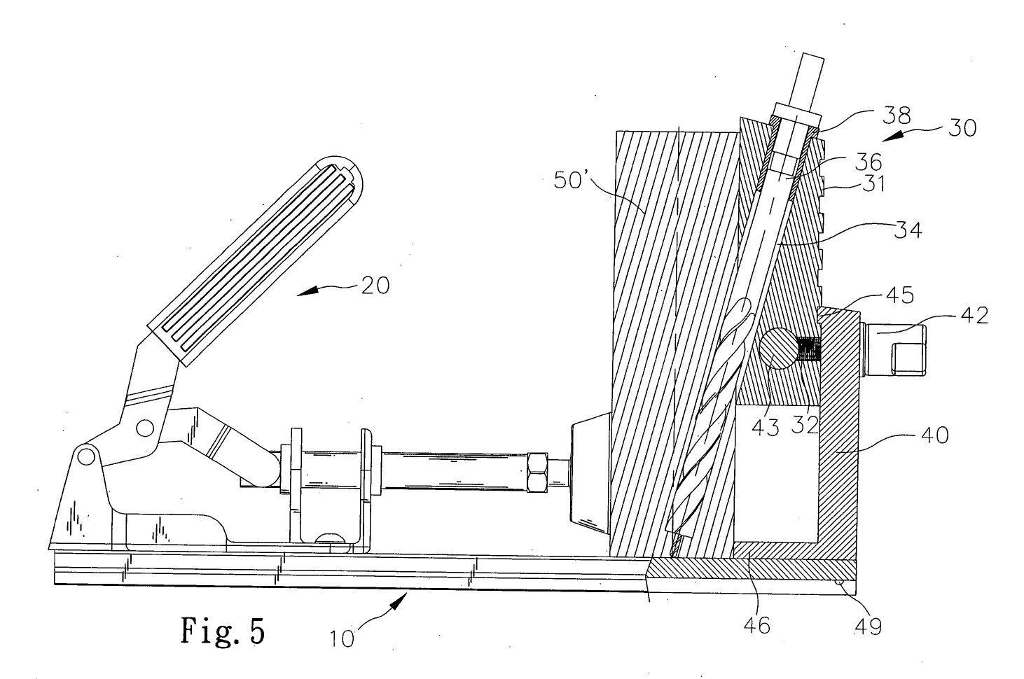

The process discussed above referring to FIGS. 4 and 5 can be repeated to bore the wooden workpiece 50 with more pairs of holes.

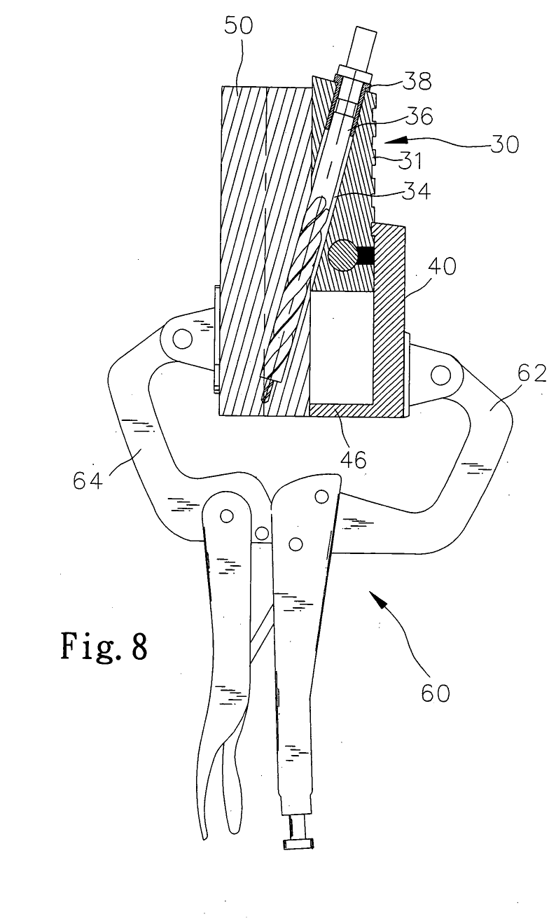

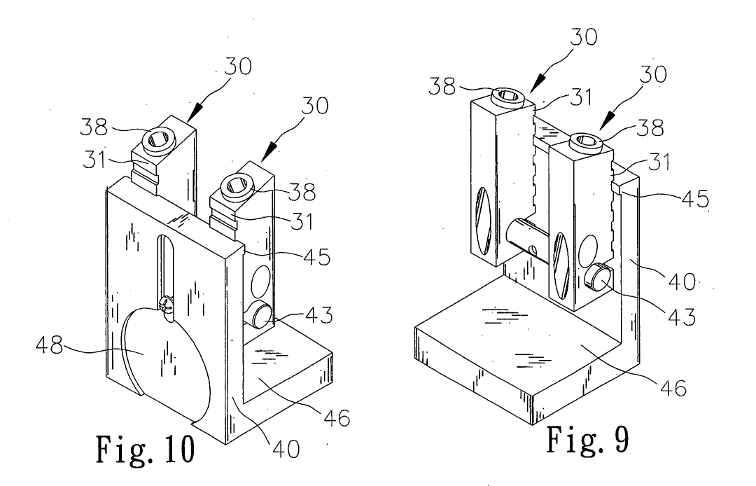

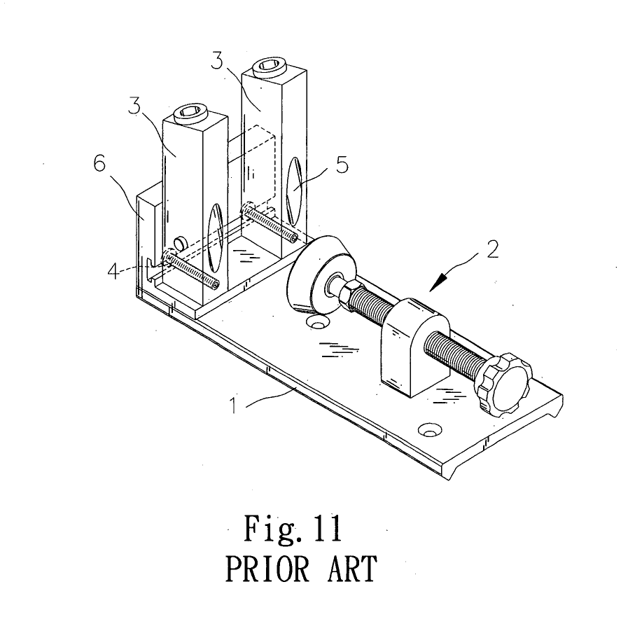

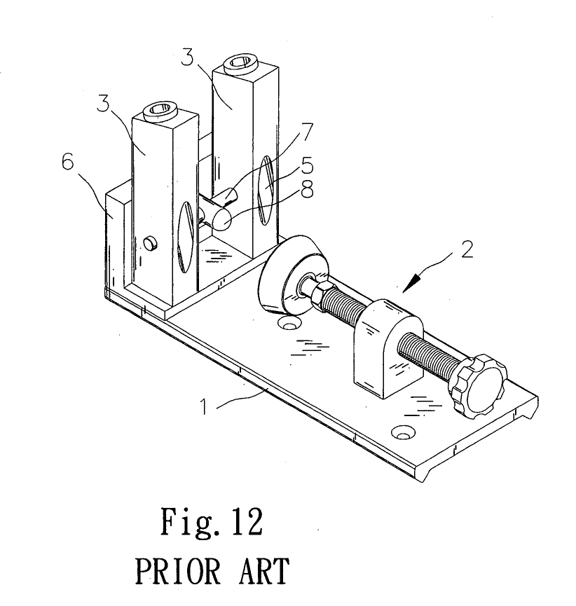

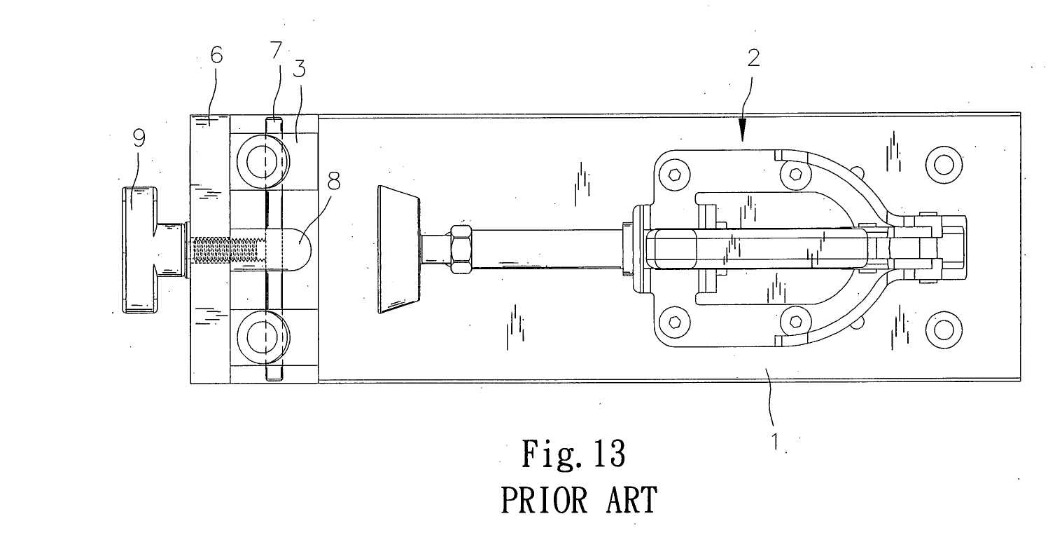

FIGS. 8 to 10 show a wood-drilling apparatus according to a second embodiment of the present invention. The second embodiment is identical to the first embodiment except for including a face clamp 60 instead of the table 10 and the jig 20. The face clamp 60 includes a first jaw 62 and a second jaw 64. In use, the first jaw 62 is put against the wall 40, and the second jaw 64 the wooden workpiece 50. The wall 40 defines a recess 48 for receiving the first jaw 62.

The present invention has been described through detailed illustration of two embodiments. Those skilled in the art can derive variation from the embodiments without departing from the scope of the present invention. Therefore, the embodiments shall not limit the scope of the present invention defined in the claims.

1. A wood-drilling apparatus comprising:
a table;
a wall installed on the table;
at least one cylinder vertically movably mounted on the wall, the cylinder defining an inclined passageway;
a jig installed on the table for pushing a workpiece against the cylinder; and
at least one drill movably inserted in the inclined passageway for drilling the workpiece:

2. The wood-drilling apparatus according to claim 1 including a screw driven into the cylinder, wherein the wall defines a vertical slot through which the screw is inserted and along which the screw is movable.

3. The wood-drilling apparatus according to claim 1 including two cylinders.

4. The wood-drilling apparatus according to claim 3 including a rod for carrying the cylinders.

5. The wood-drilling apparatus according to claim 4, wherein each of the cylinders defines a hole for receiving the rod.

6. The wood-drilling apparatus according to claim 4 including a screw driven into the rod, wherein the wall defines a vertical slot through which the screw is inserted and along which the screw is movable.

7. The wood-drilling apparatus according to claim 6 wherein the rod defines a screw hole for receiving the screw.

8. The wood-drilling apparatus according to claim 1, wherein the wall includes a rib formed thereon, and the cylinder includes a plurality of ribs for engagement with the rib of the wall.

9. A wood-drilling apparatus comprising:
a wall installed on the table;
at least one cylinder defining an inclined passageway, wherein the cylinder is vertically movably mounted on the wall;
a clamp for clamping a workpiece, the cylinder and the wall against one another; and
at least one drill movably inserted in the inclined passageway for drilling the workpiece.

10. The wood-drilling apparatus according to claim 9 including a screw driven into the cylinder, wherein the wall defines a vertical slot through which the screw is inserted and along which the screw is movable.

11. The wood-drilling apparatus according to claim 9 including two cylinders.

12. The wood-drilling apparatus according to claim 11 including a rod for carrying the cylinders.

13. The wood-drilling apparatus according to claim 12, wherein each of the cylinders defines a hole for receiving the rod.

14. The wood-drilling apparatus according to claim 12 including a screw driven into the rod, wherein the wall defines a vertical slot through which the screw is inserted and along which the screw is movable.

15. The wood-drilling apparatus according to claim 14 wherein the rod defines a screw hole for receiving the screw.

16. The wood-drilling apparatus according to claim 9, wherein the wall includes a rib formed thereon, and the cylinder includes a plurality of ribs for engagement with the rib of the wall.

17. The wood-drilling apparatus according to claim 9 wherein the wall defines a recess for receiving a jaw of the clamp.

18. The wood-drilling apparatus according to claim 9 wherein the clamp is a face clamp.
